(19) United States
(12) Patent Application Publication
(10) Pub. No.: US 2009/0294674 A1
(43) Pub. Date: Dec. 3, 2009

(54) Method and Device for Eliminating Parasite Reflections During Inspection of Translucent or Transparent Hollow Objects

(76) Inventor: Guillaume Bathelet, Marcy L'etoile (FR)

Correspondence Address: CLARK & BRODY, 1090 VERMONT AVENUE, NW, SUITE 250, WASHINGTON, DC, 20005, US

(21) Appl. No.: 11/887,961

(22) PCT Filed: Apr. 6, 2006
(86) PCT No.: PCT/FR2006/050310

§ 371 Date: Jan. 23, 2009

(30) Foreign Application Priority Data
Apr. 6, 2005 (FR) 0503432

(51) Int. Cl. G01J 5/02; G01J 5/00

(52) U.S. Cl. 250/340; 250/338.1

(57) ABSTRACT

The invention relates to a process for inspecting, by means of at least one sensor (6) sensitive to infrared radiation, hollow transparent or translucid objects (2) at high temperature leaving different moulding cavities (4). According to the invention, to inspect an object the infrared radiation taken into account for the sensitive sensor, and the infrared radiation reflected by said object and issuing from nearby infrared sources to said object are eliminated.

The present invention relates to the technical field of inspection of high-temperature hollow, translucid or transparent articles or objects.

The object of the invention is more precisely high-rate inspection of objects such as glass bottles or flasks leaving a manufacturing or moulding machine.

In the preferred field of the fabrication of glass objects, it is known to utilise infrared radiation emitted by objects leaving the moulding machine in order to perform control or inspection with a view to detect possible defects on the surface or inside objects. The quality control of such objects is necessary to eliminate those having defects likely to affect their aesthetic character or worse constitute a real danger for the ultimate user.

In classic terms, the moulding machine is constituted by different cavities each equipped with a mould in which the object takes its final form at high temperature. On leaving the moulding machine, the objects are forwarded so as to constitute a file on a conveyor belt causing the objects to defiler successively to various processing stations, such as pulverisation and annealing.

It appears meaningful to identify a moulding defect which is the most possible as it leaves the moulding machine prior to the various processing stations, so as to correct it as soon as possible at the moulding machine. In the prior art, various solutions have been proposed for inspecting objects at high temperature leaving a moulding machine.

For example, the patent GB 9 408 446 describes apparatus constituted by two infrared sensors placed on either side of the conveyor routing the objects as they leave the moulding machine. These sensors each generate a signal in response to heat radiation emitted by the objects. If such a signal does not correspond to a predetermined model, the objects are considered to be defective. It should be noted that this detection principle consists of storing for each cavity the image of an object considered as good so as to serve as reference model.

And, document DE 199 02 316 proposes analysing the thermal profile of objects recovered by the infrared sensor in light of determining statistically for each cavity an anticipated thermal profile which is compared to the thermal profile measuring in light of detecting the state of failure or not of the objects.

Independently of the disadvantages resulting from the techniques described hereinabove, the applicant has revealed that measuring the infrared radiation for each object is voidable by error due to other sources of infrared radiation which are reflected on the surface inspected. For example, these sources of infrared radiation considered as parasitic can be objects placed upstream or downstream of the inspected object, objects prior to their moulding or objects located on another production line.

The object of the invention is therefore to rectify the disadvantages mentioned hereinabove in proposing an optical process for limiting or even eliminating the influence of sources of infrared radiation near the inspected object during measuring of the infrared radiation emitted by said object.

Another object of the invention is to propose an optical process for eliminating the parasitic infrared radiation reflected on the inspected object so as to improve the inspection quality aimed at determining whether the inspected object is defective or not.

To attain such an objective the object of the invention relates to a process for inspecting, by means of at least one sensor sensitive to infrared radiation, hollow transparent or translucid objects at high temperature leaving different moulding cavities. According to the invention, to detect an object, whether defective or not, the infrared radiation reflected by said object and issuing from infrared sources near said object is eliminated from the infrared radiation taken into account by the sensitive sensor.

According to an embodiment, the process aims to eliminate the polarised infrared radiation according to a preferred direction.

Advantageously, the polarised infrared radiation is suppressed according to a preferred vertical direction.

According to a preferred embodiment, the polarised infrared radiation in an infrared spectral band encompassing the infrared spectral band of the measuring sensor is suppressed.

Another object of the invention is to propose a device for inspecting at high temperature hollow transparent or translucid objects leaving different moulding cavities, adapted for limiting or even eliminating the influence of sources of infrared radiation near the inspected object.

To attain such an objective the device comprises:
at least one sensor sensitive to infrared radiation emitted by the objects passing in front of the sensor,
and a unit for control and processing exit signals delivered by the sensor and adapted to determine whether an object is defective or not.
   According to the invention, the optical system of each sensitive sensor is fitted with a polariser whereof the polarisation vector is substantially orthogonal to the polarisation vector of the beams reflected by the inspected object.

The polariser preferably has a polarisation vector which is orthogonal to the polarisation vector of the beams reflected by the inspected object.

According to an embodiment the polariser has a horizontal polarisation vector.

Advantageously, the polariser ensures its polarisation function in an infrared spectral band encompassing at least the infrared spectral band of the measuring sensor.

Various other characteristics will emerge from the following description in reference to the attached diagrams which show, by way of non-limiting examples, embodiments of the object of the invention.

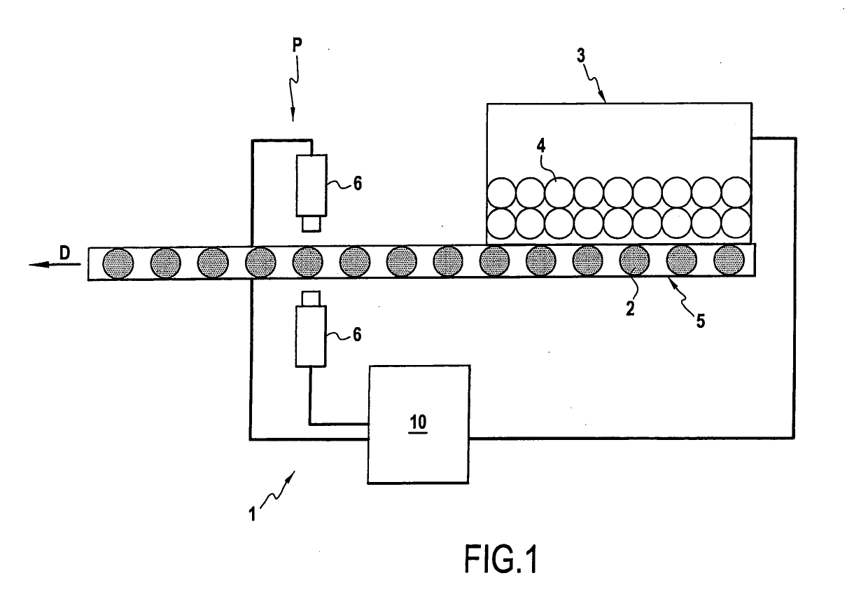

FIG. 1 is a schematic view illustrating an embodiment of an installation inspection as per the invention.

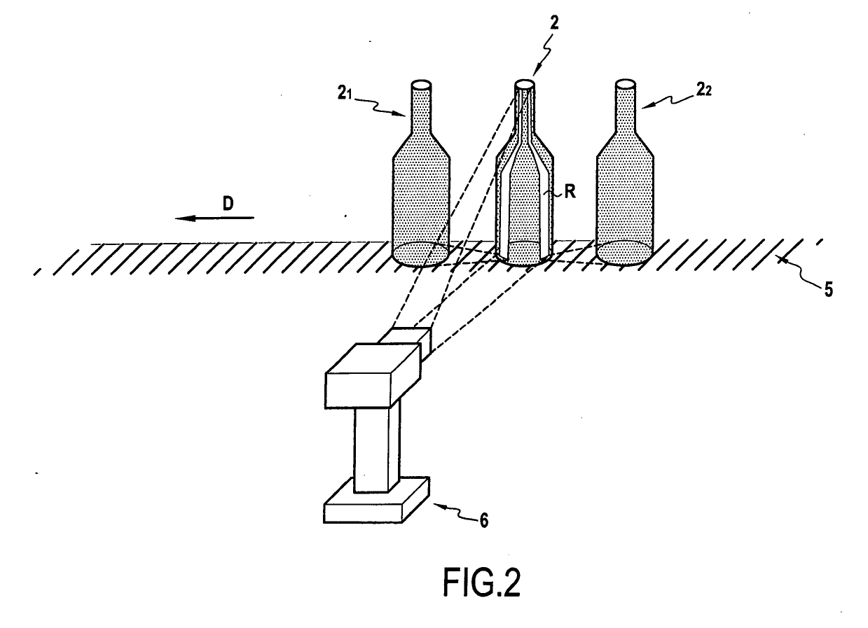

FIG. 2 illustrates the formation of parasitic reflections on the surface of an object during inspection, created by nearby objects.

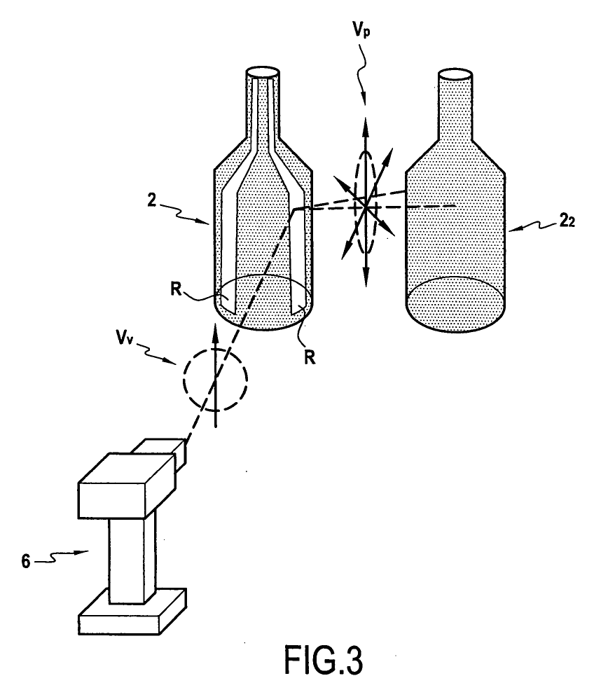

FIG. 3 illustrates the operating principle of the object of the invention.

As is more precisely evident from FIG. 1, the object of the invention relates to a device 1 for hot inspection of hollow transparent or translucid objects 2 such as for example glass bottles or flasks. The device 1 is placed so as to allow inspection of the objects 2 leaving a production or moulding 3 machine and thus having a high temperature.

The moulding machine 3 conventionally comprises a series of cavities 4 each ensuring the moulding of an object 2. In a known manner, the objects 2 which have just been moulded by the machine 3 are sent on an exit conveyor 5 such that the objects 2 constitute a file on the conveyor 5. The objects 2 are thus forwarded successively to different processing stations.

In keeping with the invention, the device I comprises a high-rate inspection or control P station for objects 2 having a high temperature. For this purpose, the inspection station P is placed as close as possible to the moulding machine so that the conveyor 5 ensures the successive filing past of objects 2 at high temperature before the inspection station P. The inspection station P comprises at least one and, in the example illustrated, two sensors 6 sensitive to infrared radiation emitted by the objects 2 passing by each sensor. In conventional terms, it should be noted that the infrared radiation emitted by the hot objects 2 extends from the near infrared to the far infrared. The sensors 6 are thus placed at the exit of the moulding machine 3 so as to be sensitive to all or part of the infrared radiation (near infrared to far infrared) emitted by the objects 2. In the illustrated example, the two sensors 6 are placed on either side of the conveyor 5 to allow inspection of both sides of the objects 2. For example, each sensor 6 is constituted by an infrared camera.

It should be noted that each sensor is directed so as to observe an object 2 downstream relative to the filing direction D of the objects. The two sensors 6 therefore extend symmetrically on either side of the conveyor 5.

Conventionally, the sensors 6 are connected to a control and processing unit 10 for exit signals delivered by the sensors 6. In fact, each sensor 6 generates an output signal, for example video, in response to the infrared radiation emitted by an object 2. Of course, the unit 10 is adapted to control the operating of the sensors 6 as an object 2 passes by in their field of vision, such that each sensor 6 takes an image of each of the high-rate moving objects 2. The images taken by the sensor(s) 6 are analysed by the unit 10 during an inspection step, especially to search for possible defects of the objects 2 or to analyse the functioning of the moulding process. The unit 10 is thus adapted for determining whether the objects inspected are defective or not. More precisely, the unit 10 determines whether the inspected object has defects on the surface and/or in the material constituting the inspected object.

According to the invention, the optical system of each sensitive sensor 6 is fitted with an optical polariser for limiting or even eliminating the infrared radiation reflected by the inspected object and issuing from adjacent sources to said inspected object and considered as being parasitic sources of infrared radiation.

In fact, it must be considered that heat sources close to the inspected object, in this case 2 in the example illustrated in FIG. 2, generate parasitic reflections R on the surface of the inspected object 2. For example, the downstream 2₁ and upstream 2₂ objects to said inspected object 2, placed on the conveyor 5, are at a temperature close to the inspected object and emit infrared radiation which is reflected on the surface of the inspected object 2, which perturbs the measuring of the infrared radiation made by each sensor 6. It follows that measuring of the radiation received by each sensor 6 is a function of the non-polarised direct radiation of the inspected object 2 and of the radiation reflected on the surface of said object 2 and originating from adjacent objects. Of course, other heat sources can be reflected on the surface of the inspected object 2 such as the objects prior to their moulding or objects at high temperature produced on an adjoining line.

As is evident from the example illustrated in FIG. 3, the nearby or parasitic infrared source 2₂ emits in the direction of the object to be inspected 2 infrared radiation of which the polarisation vector V_{P} has multiple non-preferred directions. The parasitic reflections R due to this parasitic heat source 2₂ and which are reflected on the surface of the object to be inspected 2 are for the most part polarised according to a preferred direction. In the illustrated example, infrared radiation coming from parasitic reflections R has polarisation vector V_{V} of vertical direction.

The object of the invention therefore aims to place in the optical system of each measuring sensor 6 a polariser oriented in the substantially orthogonal direction and preferably in the orthogonal direction to this preferred direction of the polarisation vector of the infrared radiation reflected by the surface of the inspected object 2. Such a polariser cancels the infrared radiation taken into account by each measuring sensor, the infrared radiation reflected by the surface of the inspected object 2 and issuing from nearby sources 2₁, 2₂ in the embodiment in question.

In the illustrated example, the polariser has a horizontal polarisation vector, that is, orthogonal to the polarisation vector V_{V} of the infrared radiation parasitic. According to a preferred embodiment, it can be provided to make the polariser by means of a polarised linear filter or by means of other optical elements such as for example a circular or elliptical polariser. The polariser assumes its polarisation function in an infrared spectral band encompassing at least the infrared spectral band of the measuring sensor.

It emerges from the object of the invention that the infrared radiation taken into account corresponds to the direct non-polarised radiation of the inspected object for precisely determining whether the inspected object is defective or not. In other terms, the object of the invention improves detection of defects appearing on the surface and/or in the material constituting the inspected object.

The invention is not limited to the examples described and illustrated, since various modifications can be made without departing from its scope.

1. A process for inspecting, by means of at least one sensor (6) sensitive to infrared radiation, hollow transparent or translucid objects (2) at high temperature leaving different moulding cavities (4), characterised in that for detecting whether an object is defective or not, the infrared radiation reflected (R) by said object and issuing from infrared sources adjacent to said object is eliminated from the infrared radiation taken into account by the sensitive sensor.

2. The process as claimed in claim 1, characterised in that the polarised infrared radiation according to a preferred direction is eliminated.

3. The process as claimed in claim 2, characterised in that the polarised infrared radiation according to a preferred vertical direction is eliminated.

4. The process as claimed in claim 2, characterised in that the polarised infrared radiation in an infrared spectral band encompassing the infrared spectral band of the measuring sensor is eliminated.

5. A device for hot inspection of hollow transparent or translucid objects (2) leaving moulding cavities (4), the device comprising:
at least one sensor (6) sensitive to infrared radiation emitted by the objects (2) passing in front of the sensor,
and a control and processing unit (10) for output signals delivered by the sensor and adapted for determining whether an object is defective or not, characterised in that the optical system of each sensor sensitive (6) is fitted with a polariser whereof the polarisation vector is substantially orthogonal to the polarisation vector of the beams reflected (R) by the inspected object.

6. The device as claimed in claim 5, characterised in that the polariser has a polarisation vector which is orthogonal to the polarisation vector of the beams reflected (R) by the inspected object.

7. The device as claimed in claim 5, characterised in that the polariser has a horizontal polarisation vector.

8. The device as claimed in claim 5, characterised in that the polariser ensures its polarisation function in an infrared spectral band encompassing at least the infrared spectral band of the measuring sensor.

9. The process as claimed in claim 3, characterised in that the polarised infrared radiation in an infrared spectral band encompassing the infrared spectral band of the measuring sensor is eliminated.

10. The device as claimed in claim 6, characterised in that the polariser has a horizontal polarisation vector.

11. The device as claimed in claim 6, characterised in that the polariser ensures its polarisation function in an infrared spectral band encompassing at least the infrared spectral band of the measuring sensor.

12. The device as claimed in claim 7, characterised in that the polariser ensures its polarisation function in an infrared spectral band encompassing at least the infrared spectral band of the measuring sensor.
